(19) United States
(12) Patent Application Publication
(10) Pub. No.: US 2005/0095565 A1
(43) Pub. Date: May 5, 2005

(54) Method of teaching mathematical operations and functions using a new numerical notation system

(76) Inventors: Joel S. Steinberg, Willoughby, OH (US); Harold Larson, (US)

Correspondence Address: Scott A. McCollister, Esq.;Fay, Sharpe, Fagan, Minnich & McKee, LLP, Seventh Floor, 1100 Superior Avenue, Cleveland, OH, 44114-2518, US

(21) Appl. No.: 10/977,194

(22) Filed: Oct. 29, 2004

Related U.S. Application Data
(60) Provisional application No. 60/515,894, filed on Oct. 30, 2003.

(51) Int. Cl. G09B 19/02

(52) U.S. Cl. 434/191

(57) ABSTRACT

A method of teaching mathematical operations is disclosed. The method includes employing a new numerical notation system. The numerical notation system is comprised of a vertical line (staff) and a plurality of points along the vertical line. The points along the vertical represent a numerical value, and any point along the vertical line has a value equal to two times the value of the immediately preceding point. One point along the vertical line is designated as the unity point, which is the point at which whole integers begin. The unity point has a numerical value of one (1). Points above the unity point represent fractional values. The numerical notation system indicates or represents a number value by one or more perpendicular lines (flags) extending to the right or left of the vertical line represent negative values. A number value is represented in the notation system by the sum of the value of the perpendicular lines extending from the points along the vertical line. The method, which employs the numerical notation system, is useful for, among other things, teaching the nature and features of mathematical operations and helping people understand multi-base arithmetic. The numerical notational system may be useful to teach mathematical concepts to children and adults who have math learning disabilities.

The present application claims priority under 35 U.S.C. § 119(e)(1) to U.S. Application No. 60/515,894, which was filed on Oct. 30, 2003.

### BACKGROUND

The present disclosure relates, in various exemplary embodiments, to a new numerical notation system. The disclosure also relates to a method for teaching various mathematical operations and concepts using such a numerical notation system.

Before humankind began to use counting numbers, tally marks were used as a record keeping system. A tally mark simply consisted of a cut in a stick, a knot in a piece of rope, a mark on a piece of paper, or some other similar representation. Each tally mark stood for an object in a collection on a one-to-one basis. The use of tally marks was not a true counting system, but did allow for a person to keep track of whether or not all members of a group of things being counted were still present in the group when it was “re-counted” or compared. Later, tally marks were grouped for convenience in visualizing the total number of members in a group.

Until Hindu-Arabic numerals were introduced to Europe in the 12^{th} Century, the numerical system in common usage in the Western world was the Roman numeral system. Most scholars agree that Roman numerals were suitable only for writing down results of calculations made on an abacus or by using some other system. Roman numerals were not easily manipulatable by the individual who was writing them down. Rather, Roman numerals primarily served as a permanent record of the results of a calculation.

The development of Hindu-Arabic numerals was a major step forward from Roman numerals. Hindu-Arabic numerals emphasized place order to indicate what power of ten the particular coefficient of ten being written stood for. Many scholars have regarded the introduction of the “zero (0),” which kept the place order if there were no powers of ten for that particular column, as a step forward. The introduction of zero (0), however, also introduced problems, such as dividing by zero.

Hindu-Arabic numerals are arbitrary symbols. That is, the intrinsic meaning of Hindu-Arabic numerals is not immediately apparent. The major advantage of Hindu-Arabic numerals was/is that by learning a variety of rules Hindu-Arabic numerals could/can be manipulated by the individual using them and still serve the purpose of functioning as a peripheral memory/record keeping system. Thus, Hindu-Arabic numerals have all the record keeping advantages of the Roman numeral system and also have the added advantage of being manipulatable.

Philosophers have often questioned the issue about what is the first counting number. Some say that it is “1.” Others argue that the first counting number is “2.” Proponents of the first argument agree that the next counting number is 2. Proponents of the second argument, however, insist that if the first counting number is 1, the sequence of counting would be as follows: 1, 1, 1, 1, etc. Regardless of which is the first counting number, questions may be posed about what number properly follows 2. Using an arithmetic system, it clearly would be 3. Using a geometric progression, the next counting number would be 4. In the arithmetic series, there are also an infinite number of fractions that appear between zero and 1. This may be a difficult concept for students to understand.

While counting systems using Hindu-Arabic numerals or Roman numerals may be suitable for their intended purpose, such systems may not necessarily allow for understanding the nature of mathematical operations, or the nature of the numbers themselves. Understanding such concepts may be beneficial to people, such as, for example, children, who are learning numbers, counting, or various mathematical operations.

It is therefore desirable to provide a numerical notation system that is visual and allows for a person learning numbers of mathematical operations to learn and understand the nature of such concepts and operations. It is also desirable to provide a numerical notation system that will allow persons learning mathematics to understand multi-based arithmetic. It is yet also desirable to provide a numerical notation system that allows for persons or students to see the connection between whole numbers and fractions. It is further desirable to provide a numerical notation system that allows for the manipulation of fractions to be more easily done and understand as compared to conventional numerical systems. It is still further desirable to provide a numerical notation system that allows for students or persons studying mathematics to more easily understand or grasp the concept of negative numbers. Additionally, it is desirable to provide a numerical notation system that functions in the manner of an abacus, but uses base 2 and requires no mechanical device. It is also desirable to provide a numerical notation system that familiarizes students with base 2 and its permutations, as base 2 is the system used, in one form or another, by all digital machines. It is also desirable to provide a numerical notation system that is ideographic and iconic, such that the meaning and component factors of any number is indicated by its form.

### BRIEF DESCRIPTION

In accordance with one aspect of the present exemplary embodiment, a method of teaching mathematical operations comprises using a numerical notation system, the numerical notation system comprising a vertical line; a plurality of points along the vertical line, each point representing a numerical value equal to a successive positive or negative whole number power of two (2); and one or more lines perpendicular to the vertical line extending from at least one of the plurality of points along the vertical line, the perpendicular lines having a value corresponding to the value of the point from which it extends, wherein a number value is represented by the sum of the value of the perpendicular lines extending from the points along the vertical line.

In accordance with another aspect of the present exemplary embodiment, a method for teaching mathematical concepts or operations comprises using one or more numerical notation forms representing a number value, the numerical notation forms comprising a vertical staff; a plurality of points positioned at substantially regular intervals along the staff, each point along the staff having a numerical value corresponding to a positive or negative whole number power of 2; and one or more flags extending from one or more of the plurality of points and perpendicular to the staff, wherein flags extending to the right of the staff have a positive value, and flags to the left of the staff have a negative value, and the number value of the numerical notation form is the sum of the numerical value of the flags extending from the staff.

In accordance with still another aspect of the exemplary embodiment, a method for representing numerical values comprises providing numerical notation form representing a number value, the numerical notation forms comprising of a vertical staff, a plurality of points along the vertical staff, one point being designated the unity point and representing a numerical value of 1, each successive point along the vertical staff representing a numerical value twice the numerical value of the immediately preceding point; and one or more flags drawn perpendicular to the staff from one or more of the points along the staff, the perpendicular lines have a value corresponding to the numerical value of the point from which it is drawn, flags drawn to the right side of the vertical staff representing positive number values and flags drawn to the left of the vertical staff representing negative values, wherein the number value of the numerical notation form is equal to the sum of the numerical values of the flags drawn along the staff, and said numerical notation form is readable by a human and an optical scanning device.

### BRIEF DESCRIPTION OF THE DRAWINGS

FIG. 1 is a numerical notation form used in a mathematical notation system according to the present invention;

FIG. 2 depicts the representation of a numerical notation form having two flags at a given position in a mathematical notation system according to the present invention;

FIG. 3 depicts numerical notation forms representing number values from 1 to 18;

FIG. 4 depicts numerical notation forms representing number values from 19-36;

FIG. 5 shows, via numerical notation forms in accordance with the present disclosure, a pattern that may be observed in counting numbers for all whole exponents of two;

FIG. 6 shows several numerical notation forms having different number values including fractional number values;

FIG. 7 shows several numerical notation forms having different number values including fractional number values;

FIG. 8 shows an addition operation adding two numerical notation forms having different number values;

FIG. 9 shows an addition operation using two numerical notation forms having different number values;

FIG. 10 shows an addition operation using two numerical notation forms having different number values;

FIG. 11 shows an addition operation adding two numerical notation forms having fractional number values;

FIG. 12 shows an addition operation adding two numerical notation forms having fractional number values;

FIG. 13 shows a subtraction operation subtracting two numerical notation forms having different number values;

FIG. 14 shows a subtraction operation subtracting two numerical notation forms having different number values;

FIG. 15 shows a multiplication operation multiplying two numerical notation forms having different number values;

FIG. 16 shows a multiplication operation multiplying two numerical notation forms having different number values;

FIG. 17 shows a multiplication operation multiplying two numerical notation forms having different number values;

FIG. 18 shows a multiplication operation multiplying two numerical notation forms having different number values;

FIG. 19 shows a multiplication operation multiplying two numerical notation forms having different number values;

FIG. 20 shows a multiplication operation multiplying two numerical notation forms having fractional number values;

FIG. 21 shows a multiplication operation multiplying two numerical notation forms having fractional number values;

FIG. 22 shows a multiplication operation multiplying a numerical notation form having a fractional number value by another form having a whole number value;

FIG. 23 shows a multiplication operation multiplying a numerical notation form having a fractional number value by another form having a whole integer number value;

FIG. 24 shows a multiplication operation multiplying two numerical notation forms having fractional number values;

FIG. 25 shows a multiplication operation multiplying a numerical notation form having a whole integer number value by a numerical notation form having a fractional number value;

FIG. 26 shows a division operation dividing two numerical notation forms having different number values;

FIG. 27 shows a division operation dividing two numerical notation forms having different number values;

FIG. 28 shows a division operation dividing two numerical notation forms having different number values;

FIG. 29 shows a division operation dividing two numerical notation forms having fractional number values; and

FIG. 30 is a three-dimensional numerical notation form depicting imaginary numbers.

### DETAILED DESCRIPTION

A new numerical notation system is disclosed that is suitable for use in teaching mathematical operations, including, for example, counting, addition, subtraction, multiplication, division, and the like. The mathematical notation system employs a shape, referred to herein as a “form” or “numerical notation form,” to depict or represent a number value.

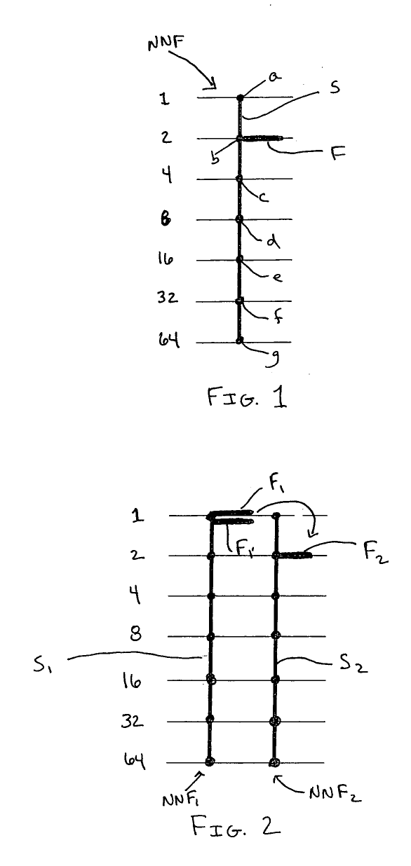

With reference to FIG. 1, a number value is represented by a form NNF, which comprises a staff S and a plurality of points or positions, a-g, along staff S. Each point a-g along staff S represents a potential numerical value. Points, such as points a-g, are positioned or occur at substantially regular intervals along the staff, such as staff S. Lined or graph paper may be employed to depict or show one or more forms, with each line serving as a potential point or position on a staff. One point or position on a staff S, in this instance the position designated a, is designated as the unity point, which is the point at which whole integers begin. The unity point has a numerical value of one (1). The points along the staff represent whole number integers and fractional values depending on the points location along the staff relative to the unity point. In one embodiment, points below the unity point represent whole number integers, while points above the unity point represent fractional values. In another embodiment, points below the unity point represent fractional values and points above the unity point represent whole number integers. The direction of decreasing or increasing value is a matter of convention that may be selected by the user of the present numerical notation forms as desired. It will be appreciated that once a particular convention is selected, that convention should be utilized throughout a given set of operations or demonstrations. For purposes of the present disclosure, the numerical notation forms utilized in the figures and examples will follow the convention that points increase in value below the unity point (i.e., points below the unit point represent whole integers) and points decrease in value above the unity point (i.e., points above the unity point represent fractional values).

With reference to FIG. 1, the numerical value for the points a-g along staff S are indicated to the left of staff S. In the present mathematical notation system, each point has a numerical value that is twice the numerical value of the immediately preceding point. Thus, all points below the unity point have a numerical value that is a whole number power of two (2), and all points above the unity point represent whole number negative powers of 2 (i.e., represent fractional values). Starting at the unity point (i.e., point a in FIG. 1) the numerical values of successive points down the staff, i.e., below the unity point, are 1, 2, 4, 8, 16, 32, 64, 128, 256, 512, 1024, 2048, etc. Thus, starting from the unity point the numerical values of the points may be represented as 2⁰, 2¹, 2², 2³, 2⁴, 2⁵, 2⁶, 2⁷, 2⁸, 2⁹, 2¹⁰, 2¹¹, etc. In the remaining figures the numerical notation forms are shown on lines or graph segments and the numerical value of the points along the staff are indicated along the left hand side of a numerical notation form. In the present disclosure, in figure depicting more than one numerical notation form, the points along a given line or graph point will have the same numerical value for each form depicted in that figure.

In the numerical notation system, a numerical notation form indicates or represents a number value by one or more perpendicular lines, referred to as a flag, extending from a point or position along the staff. A flag at a given point along the staff has a number value corresponding to the numerical value of the point from which it extends. Positive or negative number values are represented by the side on which a flag is drawn. In one embodiment, flags drawn to the right of the staff represent positive values, while flags drawn to the left of the staff represent negative values. In another embodiment, flags drawn to the left of the staff may represent positive values, while flags drawn to the right of the staff may represent negative values. With respect to all the figures presented in this disclosure, positive values are represented by flags drawn to the right of the staff and negative values are represented by flags drawn to the left of the staff. When a circumstance exists in which there is a positive value flag on one side of the staff and a negative value flag at the same position, the flags cancel each other out. With reference to FIG. 1, staff S comprises a flag F extending to the right of staff S at position b. As indicated in FIG. 1, position b corresponds to a numerical value of 2. Thus, staff S has a number value of 2.

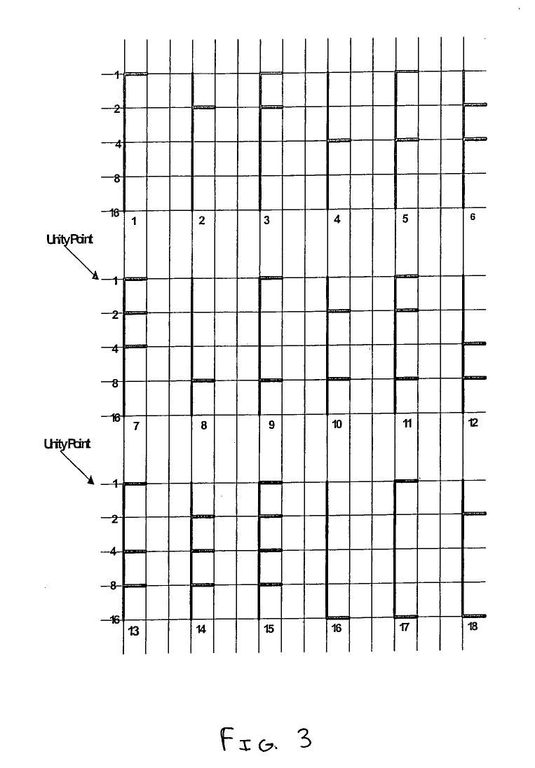

In the numerical notation system, two flags at one position are the equivalent of one flag at the next successive position, i.e., the position immediately below the position containing the two flags. Conversely, any one flag at one position is equivalent to two flags at the immediately preceding position up. By convention, no more than one flag can be at any one potential point except temporarily during manipulation of a numerical notation form during, for example, mathematical operations. With reference to FIG. 2, numerical notation form NNF₁ comprises a staff S₁ with flags F₁ and F_{1′} being drawn from the unity point. As shown in FIG. 2, the form NNF₁ may be redrawn as Form NNF₂ with flag F₂ being drawn extending from the next successive position below the unity point, i.e., the point having a numerical value 2.

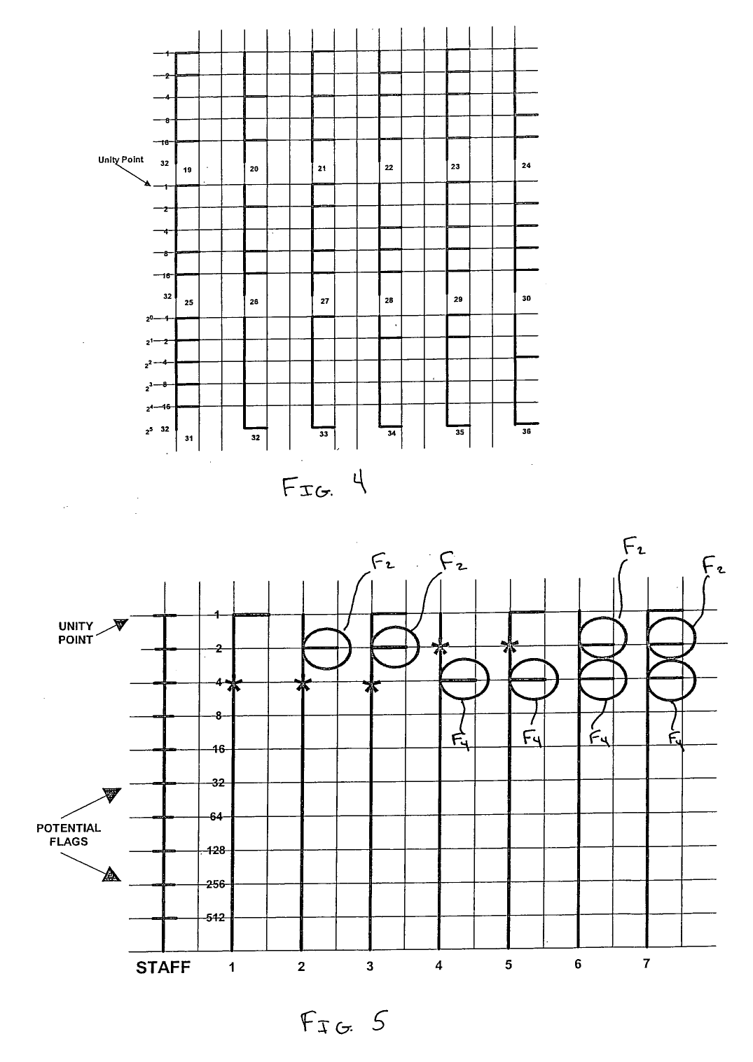

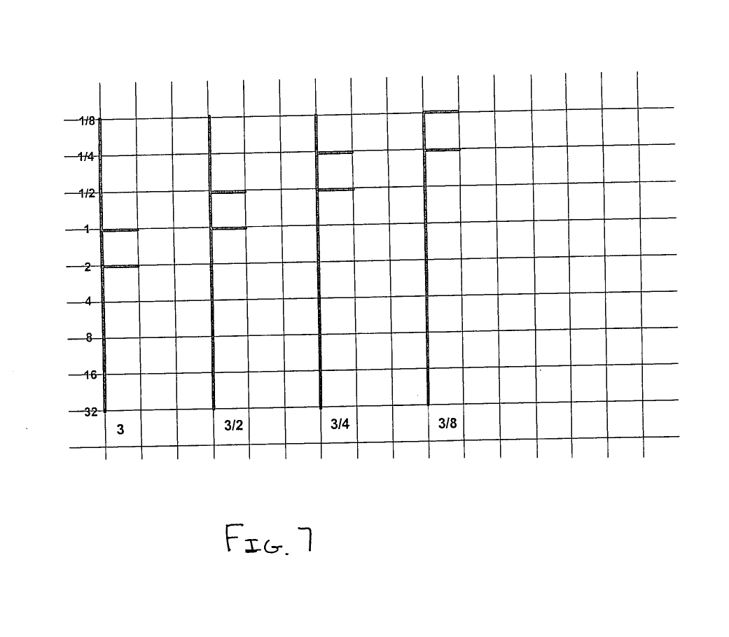

With reference to FIGS. 3 and 4, numerical notation forms may be used to represent any number and may be suitable for teaching various aspects of counting. As used herein, unless otherwise indicated, a numerical notation form is referred to with respect to the particular number value that the form represents. Generally, in the remaining figures the number value of a numerical notation form is represented immediately below the form. The number value represented by a given numerical notation form is indicated by the flag or flags drawn on a given staff. The number value represented by a particular form is the sum of the numerical value of the flags extending from the points along the staff. In FIG. 3, the number value of a particular form is indicated below that respective form. Thus, for example, the number 1 is represented by a staff having a flag drawn to the right of the staff at the unity point. The number 2 is indicated by staff having a flag drawn to the right of the staff at the position immediately below the unity point. The third form in the top row of FIG. 3 represents a number value of 3 and comprises a flag at the unity point and a flag at the point representing the numerical value 2 (i.e., sum of 1 and 2 is equal to 3). FIGS. 3 and 4 show the forms for the numbers 1 through 36. FIGS. 6 and 7 represent various number values, including fractional number values.

The given numerical notation form for a particular number value may also be thought of as a formula having a particular pattern from the unity point. For example, the numerical notation form for the number 1 has a formula “flag.” The numerical notation form for the number 2 has a formula “space-flag” from the unity point. The number 5 is represented by a numerical notation form with the formula “flag-space-flag,” and so forth. It will be appreciated that the manner in which the formula is drawn on a staff depends on whether the number value is a whole integer or a fraction. Whole integer formulas are drawn down from the unity point, while the formulas for fractions are drawn upward from the unity point. For example, the fractional value ½ also has a formula of “space-flag” from the unity point, but is drawn upward from the unity point.

Some patterns are observable with the use of the above mathematical notation system. For example, after getting to numerical notation form 4, numerical notation forms representing the numbers 1, 2, and 3 are repeated, being added onto numerical notation form 4, before numerical notation form 8 is reached. After numerical notation form 8 is reached, all numerical notation forms to form 8 are repeated, being added on to numerical notation form 8, before numerical notation form 16 is reached, and so forth.

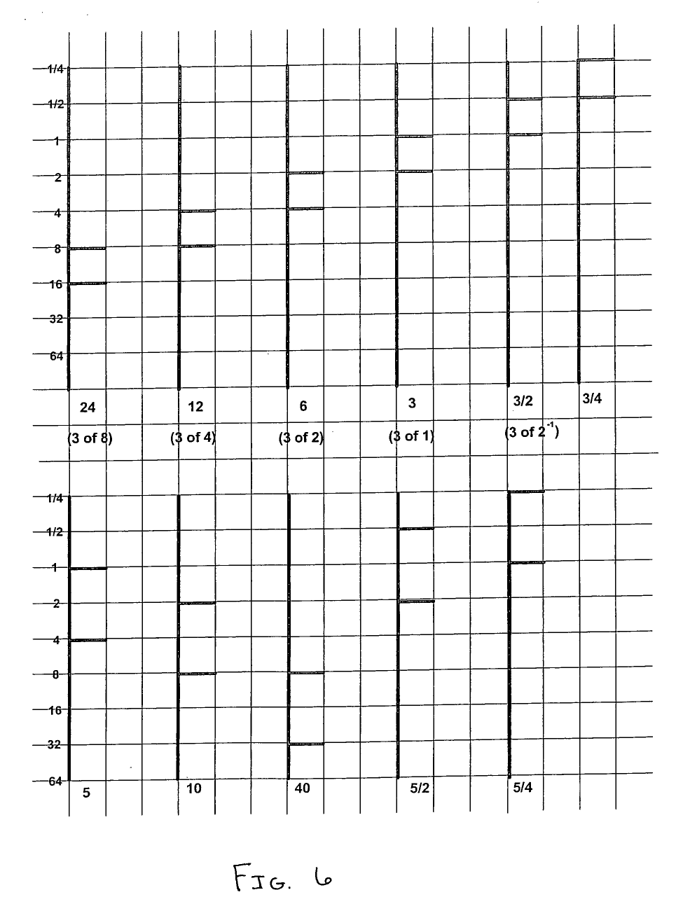

Another pattern is evident from FIG. 5. As shown in FIG. 5, the numerical value 2, as indicated by flags F₂, first appears in the numerical notation form 2. The numerical value 2 remains present for two numerical notation forms, i.e., it is also present in, for example, numerical notation form 3, then is gone for two numerical notation forms and returns for two numerical notation forms and so on. The numerical value 4 follows a similar pattern, except that it first appears, as represented by flags F₄ in FIG. 5, in numerical notation form 4, remains present for four numerical notation forms, and then is gone for four numerical notation forms, and so on. The same pattern is true for all whole exponents of two and may be observed in FIGS. 3 and 4.

It will be appreciated, especially with respect to numerical notation forms representing large number values, a given numerical notation form may be broken into separate staffs to save space on a given sheet. For example, a staff requiring spaces for values from 2⁰ to 2¹⁵ may be broken into three separate staffs wherein one staff designates 2⁰ to 2⁴, a second staff designates 2⁵ to 2⁹ and a third staff designates 2¹⁰ to 2¹⁴ and beyond. Some type of line (such as, for example, a dashed line, curved line, etc.) or other indicator is drawn to show that the staffs are connected and represent a single number value. For example, a dashed line may be drawn from the bottom of one of the staffs to the top of the next staff. The manner in which a staff is broken up may be selected as desired by the user.

Mathematical notation forms as described herein are suitable for carrying out and teaching various mathematical operations, including, for example, addition, subtraction, multiplication, division, and the like. Such operations may be carried out by applying various standards or rules that apply to the mathematical notation forms and were previously described herein. In the figures depicting various mathematical operations, numerical notation forms are generally designated by the number value they represent. Intermediate forms that are created during a given operation are designated by lower case Roman numerals. The result or product of a given operation are designated by both a lower case Roman numeral and the number value which the form represents.

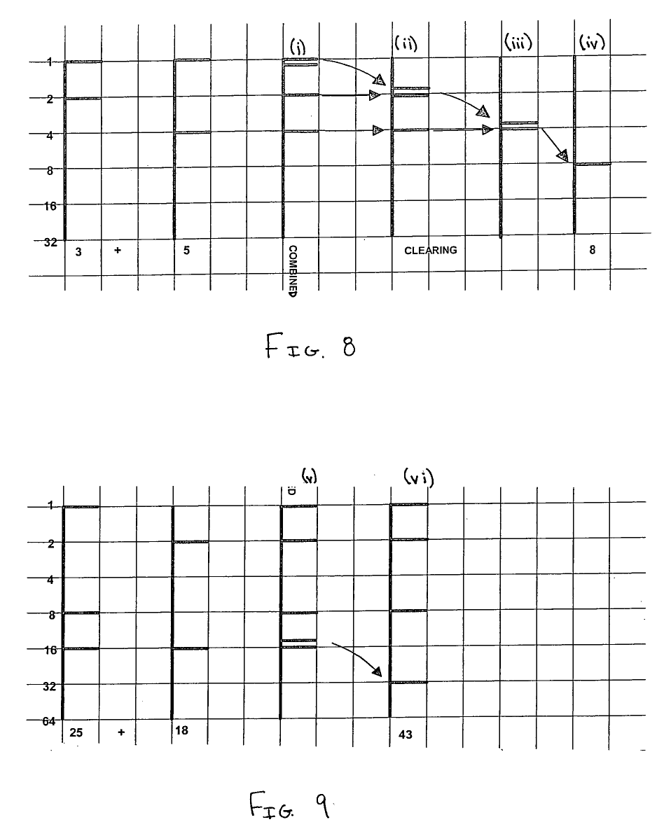

FIGS. 8-12 depict addition operations adding two numerical notation forms representing various whole or fractional number values. In general, addition operations are carried out by combining or coalescing the numerical notation forms to be added into a single form. Numerical notation forms are combined by drawing one numerical notation form on another numerical notation form. For example, if each mathematical notation form being added has a flag at a given point, then the combined form would have two flags at that point. After combining the forms, the combined form is “cleared.” “Clearing” a combined form is accomplished by drawing the combined form in its simplest form by applying the standard that a given position may comprise only one flag, thereby producing a numerical notation form representing the additive number value. In particular, the combined staff is “cleared” by applying the standard that two flags at a given position are equivalent to one flag at the next successive position down along the staff. An addition operation is more easily understood when described with reference to FIGS. 8-12.

With reference to FIG. 8, the addition operation of adding 5 to 3 is depicted. To add 5 to 3 using numerical notation forms, the numerical notation forms of 3 and 5 are combined to yield combined form (i). Form (i) is then cleared to yield the resultant form. Combined form (i) is cleared as follows. As shown in FIG. 8, combined form (i) includes two flags at the unity point. Applying the standard that a given position may only comprise one flag, and that two flags at a given position are equivalent to one flag at the next successive position down on the staff, combined form (i) may be redrawn as form (ii). Form (ii) contains two flags at the position with a numerical value of 2, which is equivalent to one flag at the next successive position down on the staff, i.e., the position point that designates a numerical value of 4. Thus, clearing form (ii) produces form (iii), which now comprises two flags at the position designating the numerical value 4. Consequently, form (iii) must also be cleared, and is redrawn to provide form (iv) with one flag at the numerical position designating a number value of 8, which is the sum of 3 plus 5.

With reference to FIG. 9, the addition operation of adding 18 to 25 is depicted. As shown in FIG. 9, combining numerical notation forms 25 and 18, produces form (v). Form (v) includes two flags at the position designating the numerical value 16, and is cleared by redrawing form (v) with a single flag at the position immediately below the position designating a numerical value of 16, i.e., the point designating a numerical value of 32. Redrawing form (v) in this manner provides form (vi), which represents the number value 43, i.e., the sum of 25 plus 18.

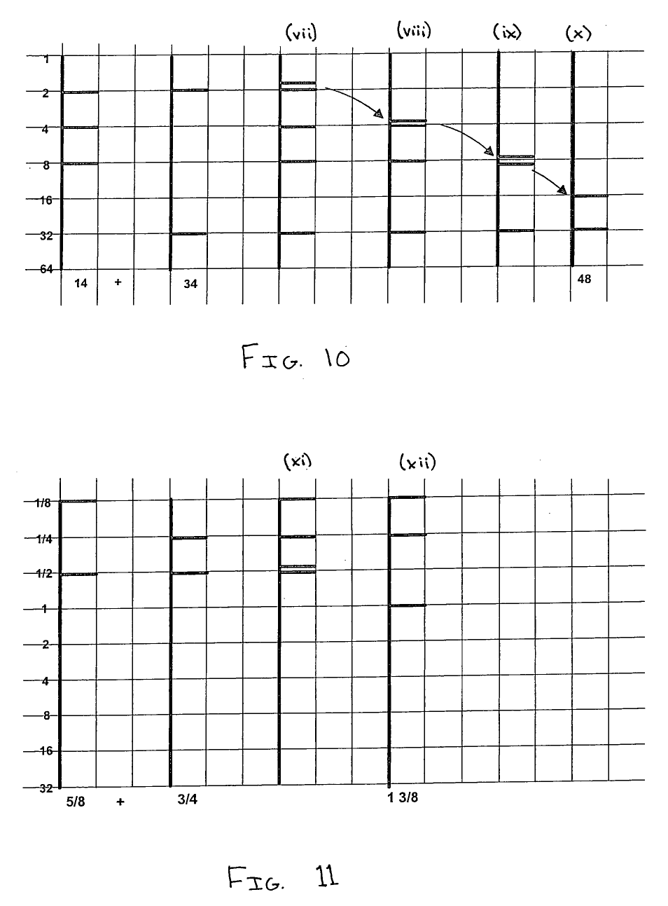

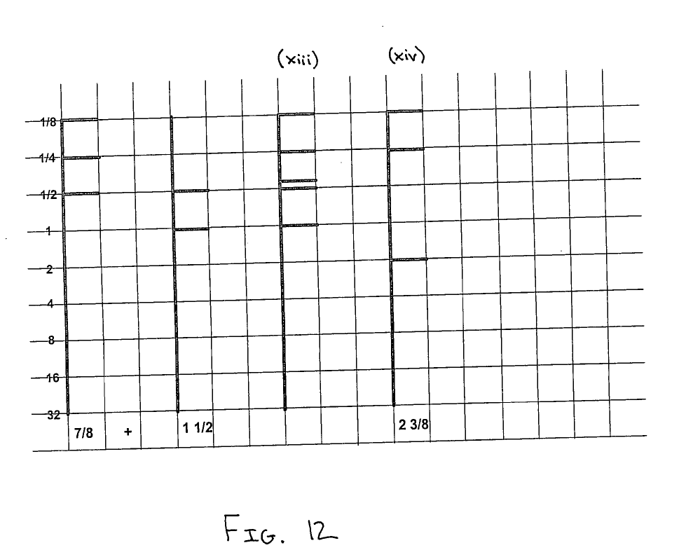

It will be appreciated that FIGS. 10-12 are just further examples of addition operations using mathematical notation forms according to the disclosure. It is noted that FIGS. 11 and 12 depict the addition of forms having fractional number values. It will be appreciated that in performing addition operations using the mathematical notation forms according to the disclosure, there is no need to seek the lowest common denominator. That is, there is no difference between how fractions and whole numbers are handled. Rather, fractions and whole numbers are just part of a continuum.

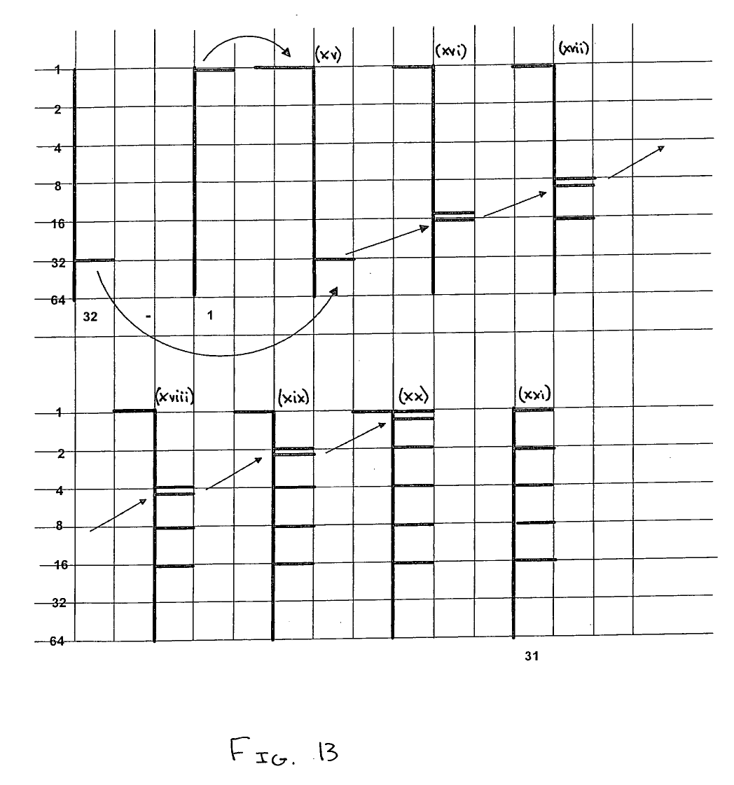

Mathematical notation forms are also suitable for carrying out and teaching subtraction operations. In carrying out a subtraction operation with mathematical notation forms according to the present disclosure, the numerical notation form representing the number to be subtracted is combined with the number being subtracted from, and the number to be subtracted is simply rewritten with its flags extending to the left of the staff. Numerical values that cancel one another out, i.e., where a flag is drawn on each side of the staff at a given position, are dropped. If a left pointing flag does not have a suitable flag to the right, a suitable flag to the right is obtained by moving a right pointing flag from below up to that level comprising the left pointing flag, bearing in mind that a flag of one level is the same as two flags at the immediately preceding level. If there are no flags available, the resultant number after clearing all possible flags has a negative value. Subtraction operations may be more readily understood with reference to the examples in FIGS. 13-14.

With reference to FIG. 13, a subtraction operation subtracting 1 from 32 is depicted. Numerical notation forms 32 and 1 are combined by redrawing the number to be subtracted, i.e., the number 1, as a negative value to yield combined form (xv). The flag at numerical value 32 is moved up to be depicted as two flags at numerical value position 16 as shown in form (xvi). As there are no suitable flags to the right at numerical value positions 8-1, this procedure is repeated throughout forms (xvii) through (xx). As shown in form (xxi), one of the positive flags drawn to the right of the staff will cancel the negative flag drawn to the left of the staff to yield form (xxi), and provide the resultant form having a number value of 31.

As shown in FIG. 13, when, during subtraction, there is a long space without flags, the flags fill from one position above the flag ending the clear space, e.g., the flag at numerical value position 32 in FIG. 13, and extend to and include the original negative flag. The operation in FIG. 13 is representative of what happens whenever there is a long gap between a minus number and a positive number. That is, each intervening position is filled with a flag beginning one position up from the lowest positive flag and extending to and including the original negative flag.

With reference to FIG. 14, while each step is not explicitly depicted, it is observed that the same situation happens with subtracting 1 from 128. Similarly, if 1 was added to 127, the results would be to continuously find two flags on each successive position from the position designating the numerical value 1 as the problem is cleared, finally leading to a single final flag one space after the last flag of the original form representing the number value 127. Thus, as a person learns to use the numerical notation forms described herein, these patterns are understood and eventually do not require mechanically carrying out the combination and clearing steps, as the operations always occur in this manner.

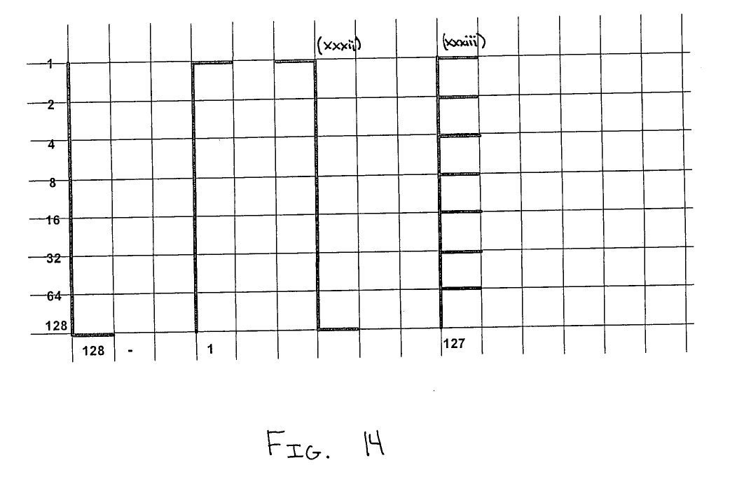

Multiplication operations may also be carried out using the numerical notation forms described herein. Multiplication using the numerical notation forms of the present disclosure essentially amounts to serial addition of the numerical notation forms. As described herein, each numerical notation form may be considered a separate formula. Multiplication using the present notation forms is performed by first writing the formula of the multiplicand (in multiplying a×b, for example, b is the multiplicand and a is the multiplier) at each position that a flag exists on the multiplier, and, second, adding the forms. That is, the resultant forms are combined and the concept that two flags at a given numerical position along the staff represent a single flag at the numerical position immediately below the numerical position comprising the two flags is applied to clear the form. A multiplication operation is described with reference to the example in FIG. 15.

FIG. 15 depicts the multiplication operation of multiplying 6 times 10, wherein 10 is the multiplicand. Thinking of numerical notation form 10, in terms of a formula of spaces and flags beginning at the unity point, numerical notation form 10 may be thought of as the formula “space-flag-space-flag.” In multiplying 6 by 10, the formula for the multiplicand 10 is written starting at each of the flags that make up the numerical notation form 6 to create two new forms (xxxiv) and (xxxv). That is, a first new form (xxxiv) is created by drawing the formula “space-flag-space-flag” starting at the point designating a numerical value of 2, i.e., the 2-flag of notation form 6, and a second new form (xxxv) is drawn by drawing the formula “space-flag-space-flag” starting at the point of the 4-flag of notation form 6. The new forms (xxxiv) and (xxxv) are then combined and cleared as necessary to provide the resultant form (xxxvi) having a number value of 60, i.e., the product of 6 times 10.

The above multiplication operation multiplying 6 times 10 may be carried out in another way that helps demonstrate the slide rule and/or mechanical function of the mathematical notation forms of the present disclosure. On a strip of paper, the multiplicand is copied at one edge. The strip is then placed at the level of each flag of the multiplier on a new staff, once for each flag in the multiplier, and the multiplicand is copied from the strip onto each new staff at each position of the flag on the multiplier. The intermediate figures are then combined or coalesced and the figure is cleared in a manner as described herein.

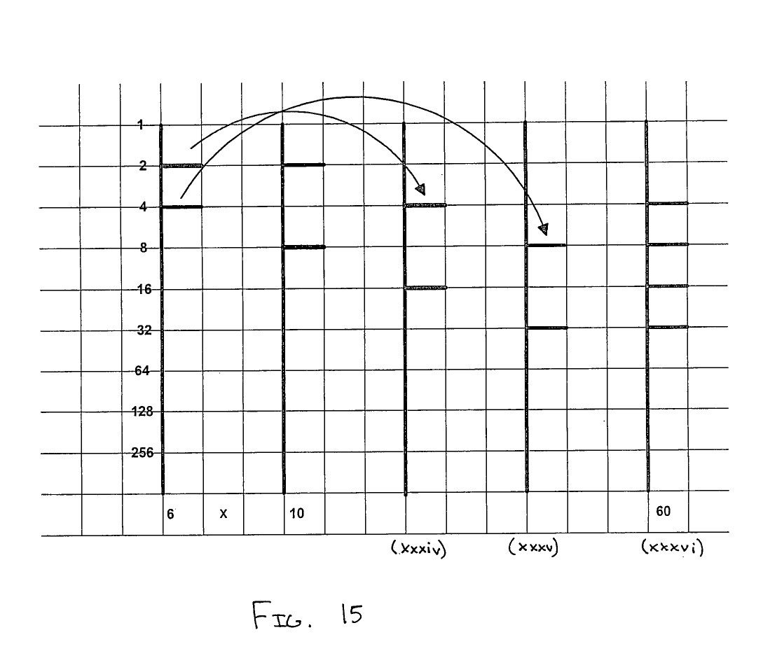

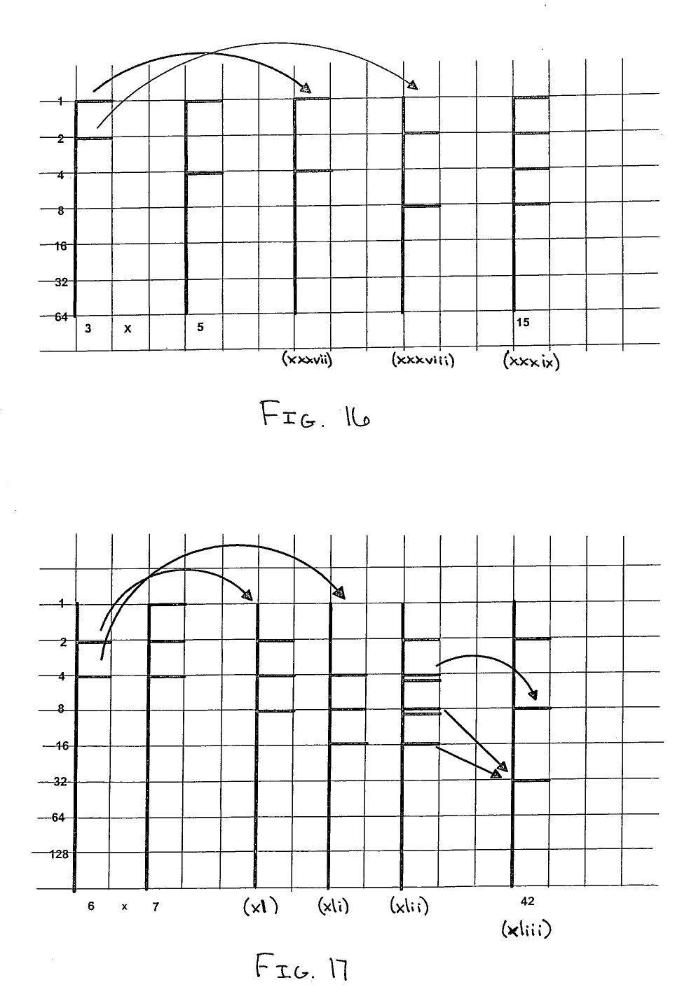

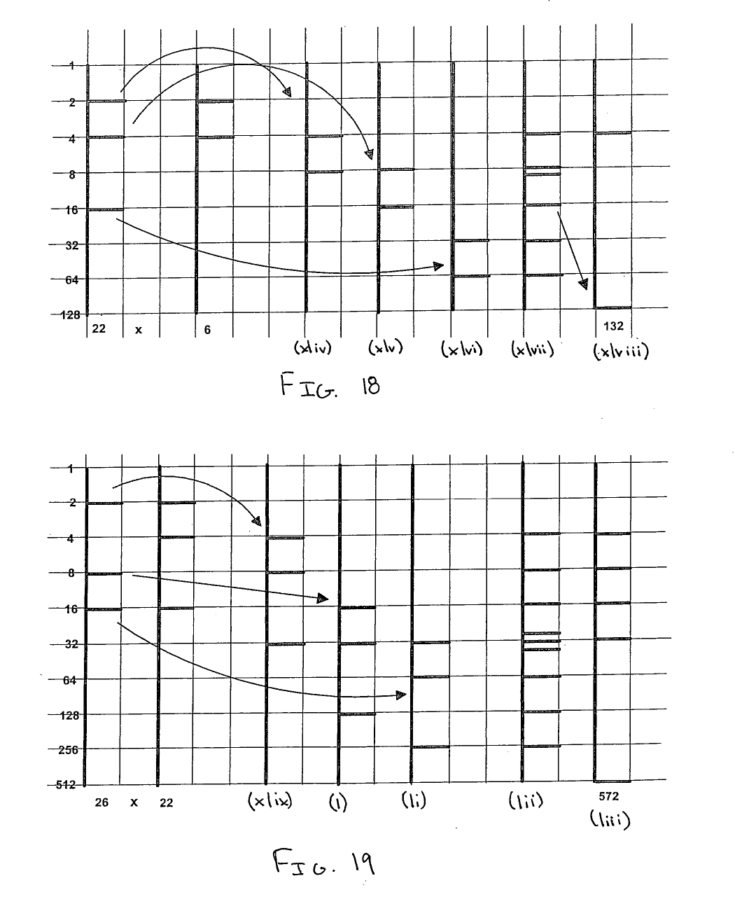

FIG. 16 depicts the multiplication operation of multiplying 3 times 5, and FIG. 17 depicts the multiplication operation of multiplying 6 times 7 using numerical notation forms in accordance with the present disclosure. Additionally, FIG. 18 depicts the multiplication operation of multiplying 22 times 6, and FIG. 19 depicts the multiplication operation of multiplying 26 by 22.

For purposes of further illustrating the performance of multiplication operations using the present numerical notation system, the multiplication operation of FIG. 17, i.e., 6×7, will be described. To carry out the operation of 6×7, the formula “flag-flag-flag” of numerical notation form 7 starting at the 2-flag and 4-flag positions, respectively, of numerical notation form 6 is drawn on new forms (xI) and (xIi). Forms (xI) and (xIi) are combined or coalesced to provide form (xIii). Form (xIii) is then cleared to yield form (xIiii) by a) rewriting the two flags of the point designating a numerical value of 8 as a single flag at numerical value point 16, and then rewriting the resultant two flags at numerical value point 16 as a single flag at numerical value point 32, and b) rewriting the two flags at numerical value point 4 as a single flag at numerical value point 8.

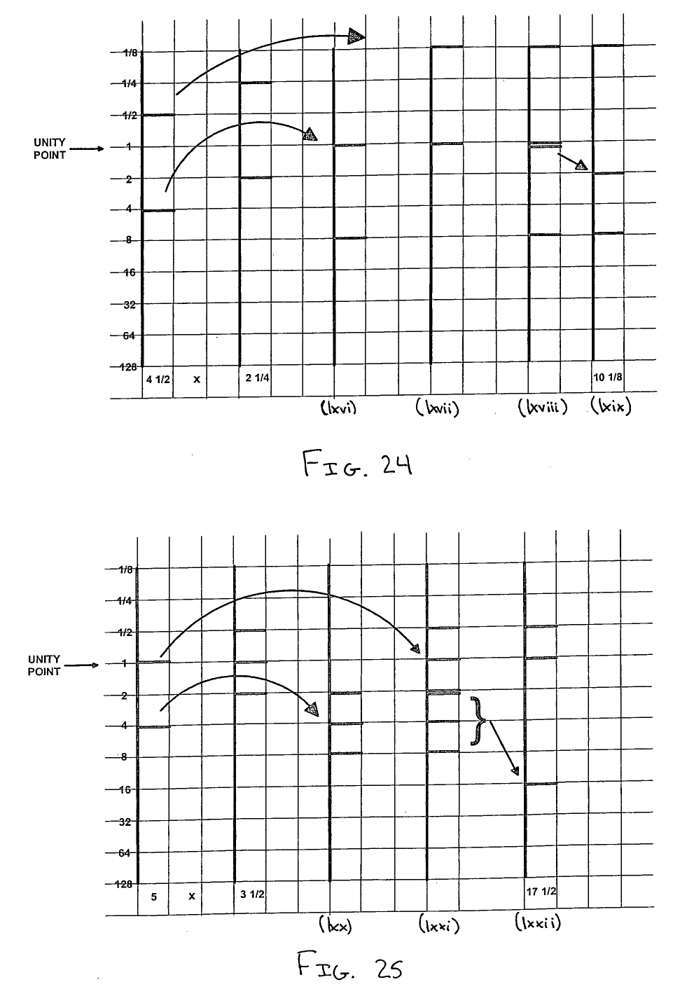

FIGS. 20-25 depict the multiplication operations involving multiplying numerical notation forms according to the present disclosure that represent fractional number values. In all instances, the method or procedure for multiplying numerical notation forms according to the present disclosure as described with respect to FIG. 15 applies to the operations performed in FIGS. 16-25. The only difference between multiplying fractions and whole numbers is that more attention to the location of the unity point is required in multiplying fractions. It is from the unity point in either direction that the formula of a particular form is drawn. This concept may be more readily understood with reference to a specific example.

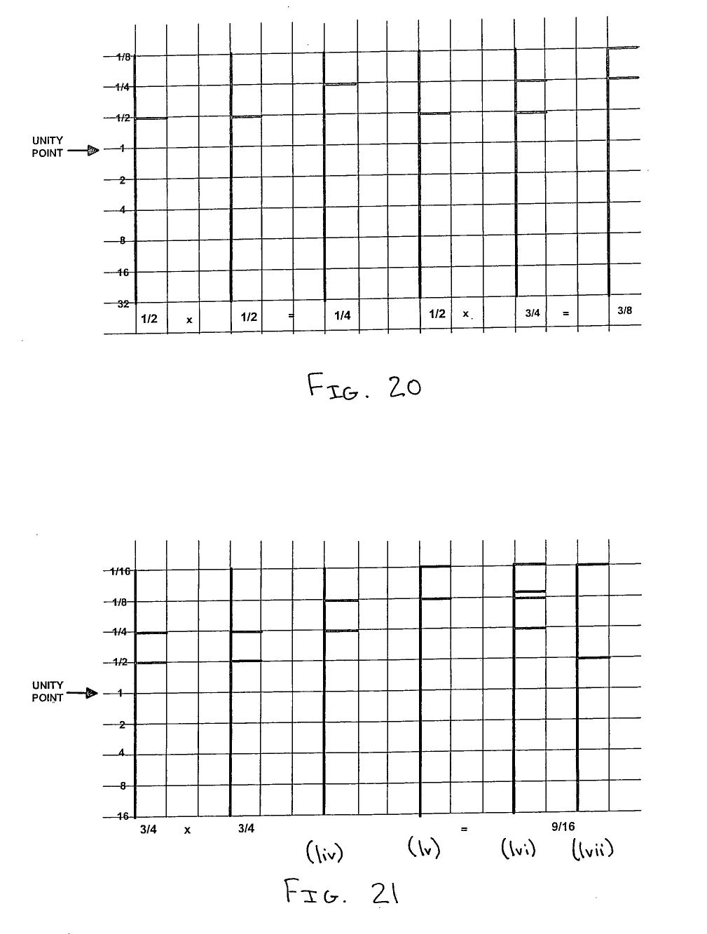

With reference to FIG. 21, the operation of multiplying ¾ by ¾ is shown. The multiplicand ¾ may be considered as having a formula “space-flag-flag” upward from the unity point. Thus, this formula is drawn in a new form from each flag of the multiplier ¾ to provide forms (Iiv) and (Iv). Forms (Iiv) and (Iv) are coalesced into form (Ivi), and form (Ivi) is cleared accordingly to provide form (Ivii), which is the numerical notation form 9/16, i.e., the product of ¾×¾.

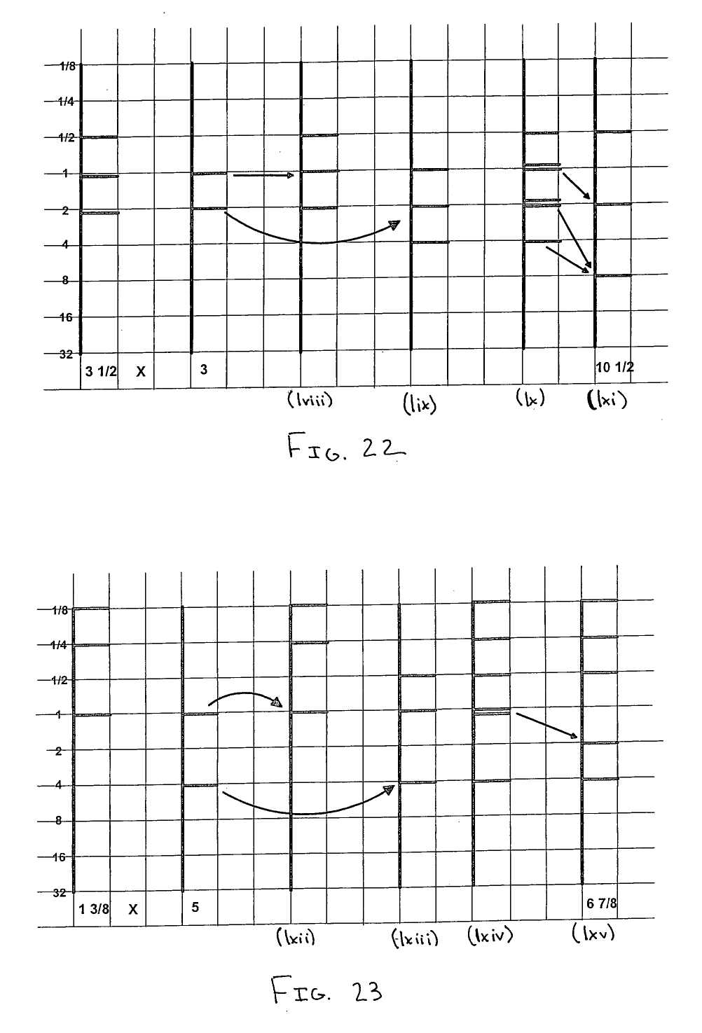

Because multiplication is communitive, multiplication operations may alternatively be carried out by writing the multiplier at each flag of the multiplicand, as shown in FIGS. 22 and 23. This may be useful in simplifying the number of forms that need to be created and added to carry out the operation. For example, in both FIGS. 22 and 23, the multiplier has three flags and would require three forms if the formula of the multiplicand were written at each of the multiplier's flags. Each multiplicand in FIGS. 22 and 23 only has two flags, and by writing the formula of the multiplier at each of the multiplicand's flag, only two forms need to be created and added. Additionally, for the multiplication of numerical notation forms with several successive staffs, such as, for example numerical notations forms representing 15, 31, 63, 127, or the like, such forms may be redrawn in a simpler form to carry out the operation. For example, instead of multiplying by 127, which comprises flags at each point from 2⁰ to 2⁶, a user may multiply by 128 minus 1, which is represented by a flag drawn to the positive side (e.g., the right side) of the staff at the position 2⁷ and a flag drawn to the negative side (e.g., the left side) of the staff at the unity point (2⁰). The reduced number of flags should simplify the operation.

Division operations may also be carried out utilizing numerical notation forms according to the present disclosure. Carrying out division with the mathematical notation forms of the disclosure simply amounts to serial subtraction while “keeping score.” Essentially, in division with the present numerical notation forms, the student or person performing the division operation is asked how many times the divisor can be subtracted from the number to be divided. The results of the repeated subtractions are simply recorded off to one side and cleared at the end of the operation. Just as in fractions, where there is no need to seek the lowest common denominator, there is no need in division to try at each step of the way to find the largest multiple of the divisor that can be subtracted from the number to be divided.

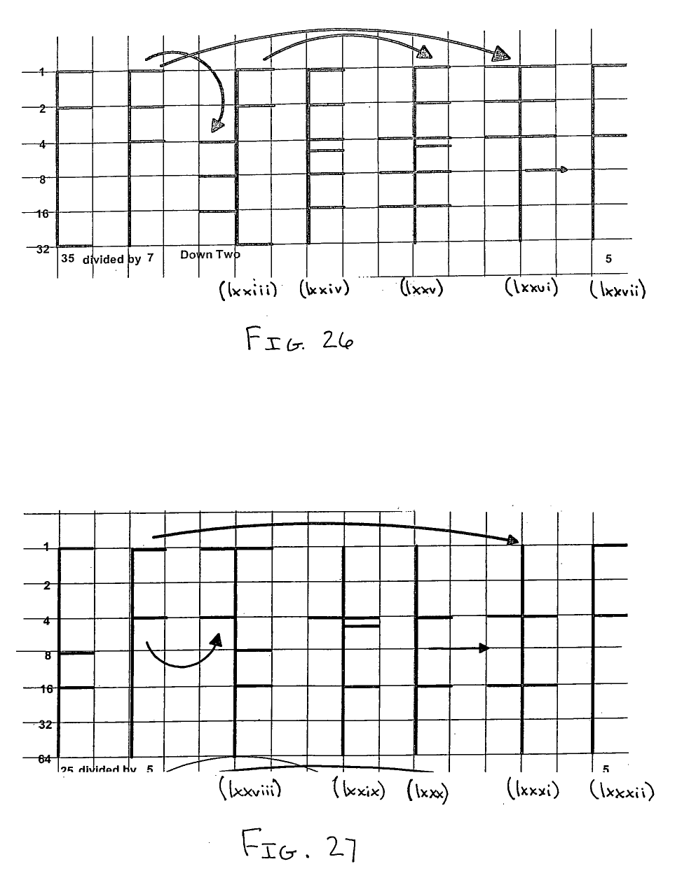

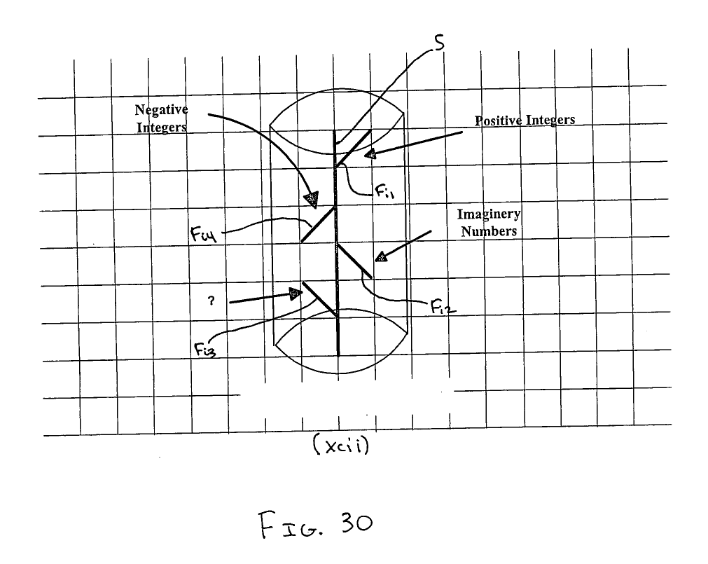

To perform a division operation, the divisor is turned into a negative number and placed at any given position along the staff of the number to be divided. A flag is made on a separate staff, which is reserved for keeping score, indicating how many positions down the formula for the divisor was placed at (on the staff of the number to be divided). For example, if the formula for the divisor is moved down two spaces on the staff of the number to be divided, a flag is made on the record keeping staff at the point two spaces down from the unity point. If the formula for the divisor is not moved down any spaces on the staff of the number to be divided, a flag is made on the record keeping staff at the unity point. The subtraction takes place and the process is repeated until there is only a single staff left, or the flags remaining on the staff to be divided are too small to subtract the divisor from. Each time the divisor is used or subtracted from the staff originally containing the number to be divided a flag is made at the appropriate point on the record keeping staff. In the case where the flags remaining on the staff to be divided are to small to subtract the divisor from, the flags remaining on the staff to be divided provide the remainder. After the process is complete, the recording, i.e., “score keeping,” staff is cleared in the usual way and that result is the answer. Division operations are depicted in FIGS. 26-29.

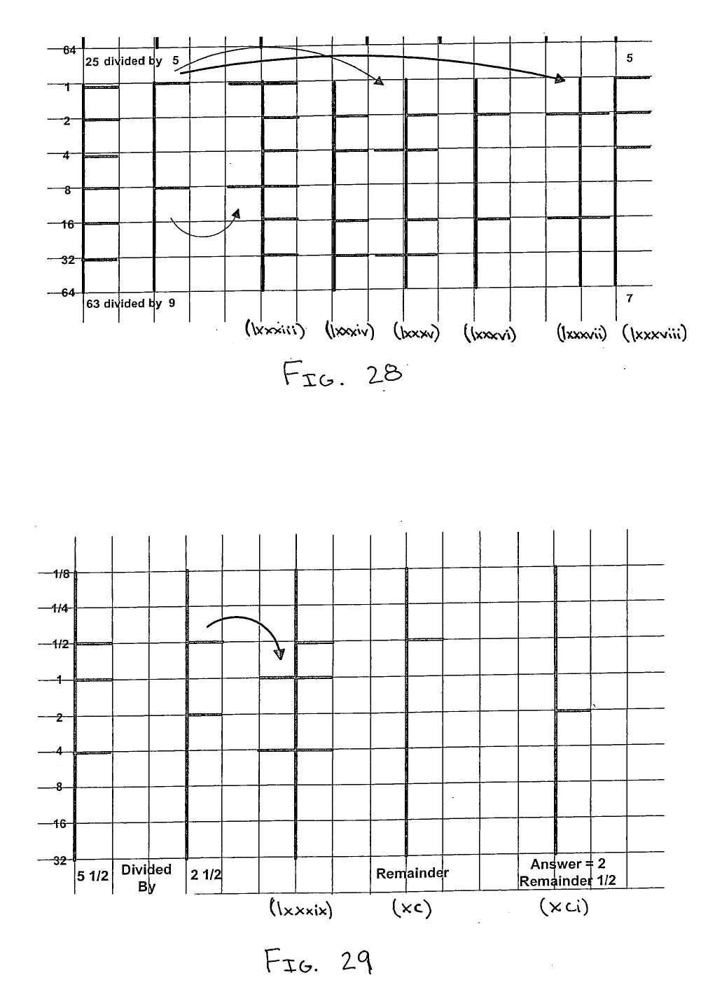

For the purposes of illustrating a division operation, reference is made to FIG. 27. FIG. 27 depicts the mathematical operation of dividing 25 by 5. That is, 25 is the number to be divided and 5 is the divisor. In FIG. 27, numerical notation form (Ixxxii) is the “score keeping” staff. As shown in FIG. 27 the divisor, i.e., the formula for “5,” was drawn as a negative value on the notation form for the number to be divided, i.e., the form for “25,” to yield notation form (Ixxviii). The formula for the divisor “5” was not moved down any spaces along the staff of the number to be divided, and so a flag would be placed at the unity point of the record keeping staff (Ixxxii). Form (Ixxviii) is cleared as shown in form (Ixxix) to yield form (Ixxx). The divisor is then used again to clear form (Ixxx). As shown in form (Ixxxi) the formula for the divisor is moved two spaces down to clear form (Ixxx). Therefore, a flag is made on the record keeping staff (Ixxxii) two spaces down from the unity point, i.e., at the point designating a numerical value of 4 (i.e., 2²). Form (Ixxxi) is cleared and no flags remain on the staff for the number to be divided. Thus, there is no remainder. Further, the record keeping staff does not have any points with two or more flags and does not need to be further cleared. Therefore, the record keeping staff (Ixxxii) provides the answer, i.e., the numerical notation form for the number “5.”

Division like multiplication, for any whole power of an exponent of 2, is done as follows: the number to be divided is simply re-written at the position the divisor is below unity point. If a person intends to divide by 8, for example, 8 is written 3 spaces down from unity point, i.e. The number to be divided is written 3 spaces further up on the staff than the position at which it was originally written.

In the case of division by a fraction that is a whole power of 2, the number to be divided is written the number of positions down from unity point that the divisor fraction is written at above unity point. For example, in the case of ½ as the divisor, it is written one position above unity point, the answer will begin being transcribed at one position below unity point. If the number being divided is “10,” for example, the operator will say to him or herself “space, flag, space flag,” describing “10” as it appears written beginning the description at unity point. That figure will be written beginning at the space that is one down from unity point. The resultant numerical notation form will read from unity point “space, space, flag, space flag,” or 20.

Other mathematical concepts may also be depicted or represented by mathematical notation forms in accordance with the present disclosure. For example, a three-dimensional form, such as form (xcii) shown in FIG. 30, may be employed to depict imaginary numbers. As shown in FIG. 30, staff S runs vertically along the X-axis, positive and negative numbers would be represented by flags drawn along the Y-axis to the right or the left of the staff respectively, and imaginary numbers may be depicted by flags, such as flags F₁, F₂, F₃, and F₄ drawn at a 90° angle from the staff in the Z-direction. Alternatively, other axes might be used to represent irrational numbers, numbers based on natural logarithms, or transcendent numbers like pi, and the like.

The use of numerical notation forms as described herein provides a number of advantages in teaching and/or learning mathematical concepts, for example, in the geometric series represented by the present numerical notation forms, positive and negative whole numbers go in the same direction, but on different sides of the staff. Thus, the equivalence of positive and negative numbers is apparent because they occupy the same numerical position value on the staff but point in different directions.

Another advantage is in the understanding or conceptualization of fractional numbers. In the arithmetic series, there are an infinite number of fractions that appear between zero and 1. This, however, is a difficult concept for students to understand. With the use of the present numerical notation forms, fractions are more easily understood, including, for example, the concept that by putting 1 over the integer of a given number, the fractional equivalent of that number is established. Such concepts may be more easily understood using the present mathematical notation forms because the universe of numbers in the present numerical notation forms folds at the unity point. For every potential position representing a whole power of 2, or any other positive number for that matter, there is a corresponding position representing the fraction that would be made up by writing the integer 1 over that particular number. Students or other persons trying to grapple with mathematical concepts may more easily and intuitively understand that the staff of the present numerical notation forms extends just as far above the unity point as it does below the unity point. Thus, the present numerical notation forms make the particular concept of an infinite number of fractions appearing between zero and 1 much more apparent.

Numerical notation forms according to the present disclosure may also be suitable for use in environments outside of educational or instructional environments. For example, the present numerical notation forms may be readable by optical scanners and by humans and be used in a consumer environment in place of artificial constructs like UPC codes.

The exemplary embodiment has been described with reference to the detailed embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of teaching mathematical operations comprising providing a numerical notation system, the numerical notation system comprising:
a vertical line;
a plurality of points along the vertical line, each point representing a numerical value equal to a successive positive or negative whole number power of two (2); and
one or more lines perpendicular to the vertical line extending from at least one of the plurality of points along the vertical line, the perpendicular lines having a value corresponding to the value of the point from which it extends, wherein a number value is represented by the sum of the value of the perpendicular lines extending from the points along the vertical line; and
teaching a user to perform a mathematical operation through manipulation of said numerical notation system.

2. The method of teaching mathematical operations according to claim 1, wherein a positive value is represented by a perpendicular line extending to the right side of the vertical line, and a negative value is represented by a perpendicular line extending to the left side of the vertical line.

3. The method according to claim 1, wherein a point along the vertical line is designated as the unity point and has a numerical value of 2⁰ (1), and points below the unity point represent a value corresponding to successive positive whole number powers of two (2) and points above the unity point represent a value corresponding to successive negative whole number powers of two (2).

4. The method according to claim 1, wherein two perpendicular lines extending from the same point along the vertical line are equivalent to one perpendicular line extending from the next successive point along the vertical line.

5. The method according to claim 1, wherein one perpendicular line extending from a point along the vertical line is equivalent to two vertical lines extending from the immediately preceding point.

6. The method according to claim 3, wherein the vertical line comprises one or more points above the unity point, said points above the unity point representing fractional values.

7. The method according to claim 1, wherein the numerical notation system is used to carry out an addition operation.

8. The method according to claim 1, wherein the numerical notation system is used to carry out a subtraction operation.

9. The method according to claim 1, wherein the numerical notation system is used to carry out a multiplication operation.

10. The method according to claim 1, wherein the numerical notation system is used to carry out a division operation.

11. The method according to claim 1, wherein perpendicular lines extending in opposite directions at a given point cancel one another out.

12. A method for teaching mathematical concepts or operations, the method comprising using one or more numerical notation forms representing a number value, the numerical notation forms comprising:
a vertical staff;
a plurality of points positioned at substantially regular intervals along the staff, each point along the staff having a numerical value corresponding to a positive or negative whole number power of 2; and
one or more flags extending from one or more of the plurality of points and perpendicular to the staff, wherein flags extending to the right of the staff have a positive value, and flags to the left of the staff have a negative value, and the number value of the numerical notation form is the sum of the numerical value of the flags extending from the staff.

13. The method according to claim 12, wherein the point having a numerical value of 2⁰ (1) is designated the unity point.

14. The method according to claim 13, wherein points above the unity point represent fractional values.

15. The method according to claim 13, wherein points below the unity point represent whole integers.

16. The method according to claim 14, wherein two flags at the same point on the staff, and extending to the same side thereof, are equivalent to one flag at the next immediately successive point on the staff.

17. The method according to claim 12, wherein perpendicular lines extending in opposite directions at a given point cancel one another out.

18. The method according to claim 12, wherein two or more numerical notation forms are employed to carry out an addition operation by
a) combining the numerical notation forms into a combined form, said combined form comprising one or more flags at each position where a flag occurred in each of the original forms;
b) reducing the combined form to its simplest form by rewriting any two flags at a single point as a single flag at the immediately subsequent point down on the staff; and
c) performing step (b) as necessary until a staff having only one flag at any given point remains.

19. The method according to claim 12, wherein two or more numerical notation forms are employed to carry out a multiplication operation between a multiplier and a multiplicand by:
a) writing the multiplicand on a separate staff at each position that a flag exists on the multiplier;
b) combining the separate staffs from step (a) into a single combined form by writing one or more flags on the combined form at each position where a flag occurs on the separate staffs;
c) reducing the combined form into its simplest form by rewriting any two flags at a single point as a single flag at the immediately subsequent point on the staff; and
d) repeating step (c) as necessary until a staff having only one flag at any given point remains.

20. A method for representing number values comprising providing a numerical notation form representing a number value, the numerical notation form comprising:
a vertical staff;
a plurality of points along the vertical staff, one point being designated the unity point and representing a numerical value of 1, each successive point along the vertical staff representing a numerical value twice the numerical value of the immediately preceding point; and
one or more flags drawn perpendicular to the staff from one or more of the points along the staff, the perpendicular lines have a value corresponding to the numerical value of the point from which it is drawn, flags drawn to the right side of the vertical staff representing positive number values and flags drawn to the left of the vertical staff representing negative values;
wherein the number value of the numerical notation form is equal to the sum of the numerical values of the flags drawn along the staff, and said numerical notation form is readable by a human and an optical scanning device.
